(19) United States
(12) Patent Application Publication
(10) Pub. No.: US 2026/0059290 A1
(43) Pub. Date: Feb. 26, 2026

(54) ELECTRONIC DEVICE, DISPLAY METHOD FOR ELECTRONIC DEVICE, AND MEDIUM

(71) Applicant: CANON KABUSHIKI KAISHA, Tokyo (JP)

(72) Inventor: NAOKI SHINOZUKA, Kanagawa (JP)

(21) Appl. No.: 19/294,858

(22) Filed: Aug. 8, 2025

(30) Foreign Application Priority Data
Aug. 21, 2024 (JP) 2024-139979

(51) Int. Cl. H04W 8/00; H04W 12/04; H04W 76/14

(52) U.S. Cl. CPC H04W 8/005; H04W 12/04; H04W 76/14

(57) ABSTRACT

An electronic device is controlled such that a search-in-progress screen is displayed when search is started by the search unit. The electronic device is controlled such that, in a case where a first external device is found by search using a first method and a predetermined condition regarding a first access point to be connected with the electronic device is satisfied, a first screen for connecting to the first external device is displayed before elapse of a predetermined time since the start of the search, without setting the second external device as a candidate for a connection destination. The electronic device is controlled such that, even if the second external device is found by a second method, a second screen indicating that search is in progress is displayed at least until the elapse of the predetermined time, unless a user operation is performed.

### BACKGROUND

### Field of the Technology

The present disclosure relates to an electronic device that performs control for connecting an external device to a wireless access point, a display method for an electronic device, and a medium.

### Description of the Related Art

In order to make an external device available to an electronic device such as an information processing device (a personal computer (PC), smartphone, etc.), there are applications that establish a connection between the electronic device and the external device, install drivers, and the like (hereinafter referred to as setup). In such an application, in order to determine an external device to be set up, processing for searching for an external device is executed for all interfaces (IFs) that the external device can support. The found external devices are then presented to the user for selection, thereby allowing the user to determine the external device to be set up. Japanese Patent Application Laid-Open No. 2022-58470 discloses a technology in which an information processing device performs processing for searching for a communication device on a network to which the information processing device is currently connected, and presents the devices that were found to the user in sequence. The technology described in Japanese Patent Application Laid-Open No. 2022-58470 also has a means for receiving Near Field Communication (NFC) information, and if NFC information is received during network search processing, the network search processing is stopped and the target communication device is determined according to the NFC information.

Incidentally, in some cases, a priority level is assigned to each of the IFs of the external devices that are searched. For this reason, in a configuration in which found external devices are presented to the user in sequence, if an external device with a low-priority IF is found first, there is a possibility that the user will select the external device with the low-priority IF. On the other hand, a mode is also conceivable in which a screen indicating that a search is in progress is displayed until the search for all IFs that can be supported by the external device ends, and thereafter high-priority external devices are presented to the user. In these cases, the user must wait until the search for all IFs ends, which is problematic in that it takes extra time, reducing operability and productivity.

### SUMMARY

According to the present disclosure, if an external device with a high-priority interface is found, that external device is immediately presented to the user.

According to one aspect of the present invention, there is provided An electronic device capable of communicating with an external device, the electronic device comprising: at least one memory and at least one processor which function as: a search unit configured to search for an external device using a plurality of methods including a first method and a second method; and a display control unit configured to control the electronic device such that a search-in-progress screen is displayed when search is started by the search unit, control the electronic device such that, in a situation where a first external device that is discoverable using the first method and a second external device that is discoverable using the second method are present, in a case where the first external device is found by search using the first method and a predetermined condition regarding a first access point to which the electronic device can be connected is satisfied, a first screen for connecting to the first external device is displayed before elapse of a predetermined time since the start of the search by the search unit, without setting the second external device as a candidate for a connection destination, and control the electronic device such that, in a situation where the external device that is discoverable using the first method is not present but the second external device that is discoverable using the second method is present, even if the second external device is found in the search using the second method, a second screen indicating that search is in progress is displayed at least until the elapse of the predetermined time, unless a user operation is performed.

According to the above configuration, when the external device with a high-priority interface is found, the external device can be immediately presented to the user. This improves user convenience and increases the productivity of processing that utilizes an external device.

Features of the present disclosure will become apparent from the following description of embodiments with reference to the attached drawings. The following description of embodiments are described by way of example.

### BRIEF DESCRIPTION OF THE DRAWINGS

FIGS. 1A and 1B are diagrams for illustrating a system configuration according to the present embodiment.

FIG. 2 is a diagram for illustrating a hardware configuration according to the present embodiment.

FIG. 3 is a flowchart showing an example of processing for searching for a printer to be set up in the present embodiment.

FIGS. 4A and 4B are flowcharts showing an example of setup target printer presentation processing in the present embodiment.

FIGS. 5A and 5B are flowcharts showing an example of processing for determining whether or not an environment allows guidance to automatic wireless setting processing in the present embodiment.

FIGS. 6A to 6D are diagrams showing examples of screens displayed on a display device 208 of a PC 101 in the setup target print presentation processing in the present embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

An information processing device and a communication device included in a communication system of the present embodiment will be described. The information processing device and the communication device may also be called an electronic device and an external device, respectively. In this embodiment, a personal computer (PC) is exemplified as the information processing device. However, the present invention is not limited to this, and can be applied to various devices such as terminal devices, smartphones, tablet terminals, PDAs (Personal Digital Assistants), and digital cameras. In addition, in the present embodiment, a printer is exemplified as a communication device, but there is no limitation to this, and the present invention can be applied to various devices that are capable of wireless communication with an information processing device. For example, in the case of printers, the present invention can be applied to inkjet printers, full-color laser beam printers, monochrome printers, and the like. In addition to printers, the present invention can also be applied to copiers, facsimile devices, terminal devices, smartphones, notebook PCs, tablet devices, PDAs, digital cameras, music playback devices, televisions, smart speakers, and the like. The present invention can also be applied to multifunction printers that have a plurality of functions, such as copying, faxing, and printing.

In the present embodiment, processing for determining a printer to be set up in setup processing performed to make the printer available to a PC will be considered. In order to make the printer available to the PC, the PC and the printer need to be able to communicate with each other. For example, by establishing a wireless infrastructure connection between the PC and the printer (hereinafter referred to as a wireless infrastructure connection), the PC and the printer become capable of communicating with each other. A wireless infrastructure connection is a method of connection via an access point (AP) in which, for example, a PC and a printer connect to the same AP and communicate with each other. That is, the user needs to connect the printer to the AP, but is required to input a Service Set Identifier (SSID) and a password for connecting the printer to the AP into the printer.

### Automatic Wireless Setting Processing

However, in order for a user to input the SSID and the password into the printer, the user must first confirm that the SSID and the password are correct, and then input them correctly from an input unit of the printer. Although the input unit of the printer includes, for example, physical buttons and a touch panel, there are limitations such as the small size of the panel and the difficulty of providing a sufficient number of physical buttons. Due to the above-mentioned circumstances, it is not easy for the user to correctly input the SSID and the password into the printer. In view of this, there is a technology in which the printer is connected to the AP without user operation (hereinafter referred to as automatic wireless setting processing). In the automatic wireless setting processing, the PC temporarily connects to the printer in a wireless setting mode (described below) via a wireless direct connection and transmits information on the AP to be connected to, such as the SSID and the password, to the printer, and the printer uses that information to connect to the AP.

The wireless direct connection is a connection method in which two devices communicate directly with each other without going through an external device such as an AP. For example, this is realized by a printer operating as an AP corresponding to a unique SSID for wireless direct connection, and a PC serving as a client connecting to a printer operating as an AP. A unique SSID is uniquely determined for a printer manufacturer and printer model. In a wireless direct connection, the PC and printer are directly connected using a wireless LAN interface (LAN IF) (described below), and therefore they cannot communicate with any device other than each other. For this reason, a wireless direct connection is often used as a temporary connection.

The wireless setting mode is an operation mode in which the printer operates as an AP corresponding to a unique SSID (hereinafter referred to as a unique SSID for the wireless setting mode) that is different from the unique SSID for a normal wireless direct connection for the automatic wireless setting processing described above. In the wireless setting mode, the printer operating as an AP is in a state where a direct wireless connection from a PC has been accepted. The wireless setting mode is a mode that is used exclusively when performing the automatic wireless setting processing described above. In the wireless setting mode, the printer operates as an AP with a low security level (an AP with open authentication) because the purpose is to connect the PC and printer without requiring the user to input authentication information (such as a password). In this embodiment, in order to acquire candidates for the printer to be set up, the PC displays a screen indicating only that a search is in progress, and searches for printers in the wireless setting mode and printers that are already able to communicate with the PC (hereinafter referred to as connected printers).

Here, a connected printer is a printer that has established a network connection such as a wireless infrastructure connection with a PC (hereinafter referred to as a network-connected printer), or a printer that has established a USB connection with a PC (hereinafter referred to as a USB-connected printer). Here, USB stands for Universal Serial Bus. Note that the network-connected printer is not limited to a wireless infrastructure connection. For example, the printer may be a printer connected to a router in a wired Local Area Network (LAN) capable of communicating with a PC via the router, may be a printer connected through wireless direct connection, or may be a combination of both.

The processing for searching for a printer in the wireless setting mode is realized by searching for the unique SSID for the wireless setting mode described above.

The processing for searching for a network-connected printer is realized by using SNMP to acquire MIB information from each device, including printers, that is present in the network environment of the PC. Here, SNMP stands for Simple Network Management Protocol, and is a protocol for network management that is a standard for managing network devices. MIB stands for Management Information Base, and is a collection of data of management information of devices. Each piece of information in the MIB is linked to a unique Object Identifier (OID), and due to the PC designating an OID using the SNMP protocol, it is possible to acquire the necessary information from the printer that is the communication destination. Since each vendor can define its own OID, by designating the unique OID that a vendor has set for the printer and acquiring specific MIB information, it can be understood that the printer is from that vendor. As a result, in the processing for searching for a network-connected printer provided by a printer vendor, only the vendor's own printers are detected as candidates to be set up. However, in the above processing, if the printer is in a sleep state, that is, if the printer is operating in a power saving mode, a response to an SNMP communication request from the PC may be delayed. In view of this, in this embodiment, the processing for searching for network-connected printers by the PC continues for 10 seconds. If the specific MIB information cannot be acquired after continuing the search processing for 10 seconds, it is determined that no network-connected printer is present in the network environment of the PC.

### Priority Level of Printer

Here, the priority level of the printer to be set up will be described. The setup processing is generally performed immediately after the purchase of the printer, when the printer is not yet connected to anything. For this reason, in this embodiment, the priority level of a printer in the wireless setting mode in which the PC automatically connects the printer to the AP is set higher than the priority order of a printer that is already connected. That is, if both a printer in the wireless setting mode and a connected printer are found, the printer in the wireless setting mode is presented to the user with priority.

As mentioned above, the processing for searching for a network-connected printer is necessarily performed for 10 seconds. For this reason, if the PC displays a screen indicating that search is in progress until the search processing for all printers is complete, the user will have to wait at least 10 seconds even if a high-priority printer in the wireless setting mode has already been found, which is inconvenient. On the other hand, if printers found in any of the IFs are presented to the user in sequence, there is a possibility that the user will select a connected printer if a low-priority connected printer is found before a printer in the wireless setting mode. In view of this, in this embodiment, a screen indicating only that a search is in progress is displayed at least until the processing for searching for a printer in the wireless setting mode ends. Then, after the processing for searching for a printer in the wireless setting mode ends, if a printer in the wireless setting mode is found, a screen prompting connection to the printer in the wireless setting mode is displayed.

The above processing procedure is implemented and realized in an application program that searches for a printer to be connected to and connects an information processing device such as a PC to the printer. To describe the above procedure in other words, an application program for searching for and connecting to a printer to be connected to searches for a first external device, that is, a printer in the wireless setting mode, using a first method, and searches for a second external device, that is, a connected printer, using a second method as well. When such a search is started, a search-in-progress screen is displayed for at least the period during which the search in the second method is being performed. In a situation where a printer in the wireless setting mode has been discovered, if a predetermined condition regarding an access point to which the printer in the wireless setting mode can be connected is satisfied, a first screen for connecting to the printer is displayed before the elapse of a predetermined time since the start of the search. In this case, even if a connected printer is found, it will not be considered a connection destination candidate. In addition, in a situation where a printer in the wireless setting mode is not found but a connected printer is found, a screen indicating that search is in progress is displayed at least until the elapse of a predetermined time, unless a user operation is performed.

This makes it possible to prompt the user to connect to a high-priority printer in the wireless setting mode without waiting 10 seconds, which is the time for searching for a connected printer. In addition, even if a low-priority connected printer is found, it will not be presented to the user until the search for a high-priority printer in the wireless setting mode ends. This makes it possible to prevent the user from erroneously selecting a low-priority connected printer as the printer to be set up, thereby improving user convenience. The present embodiment will be described in detail below.

### First Embodiment

### Example of Network Configuration

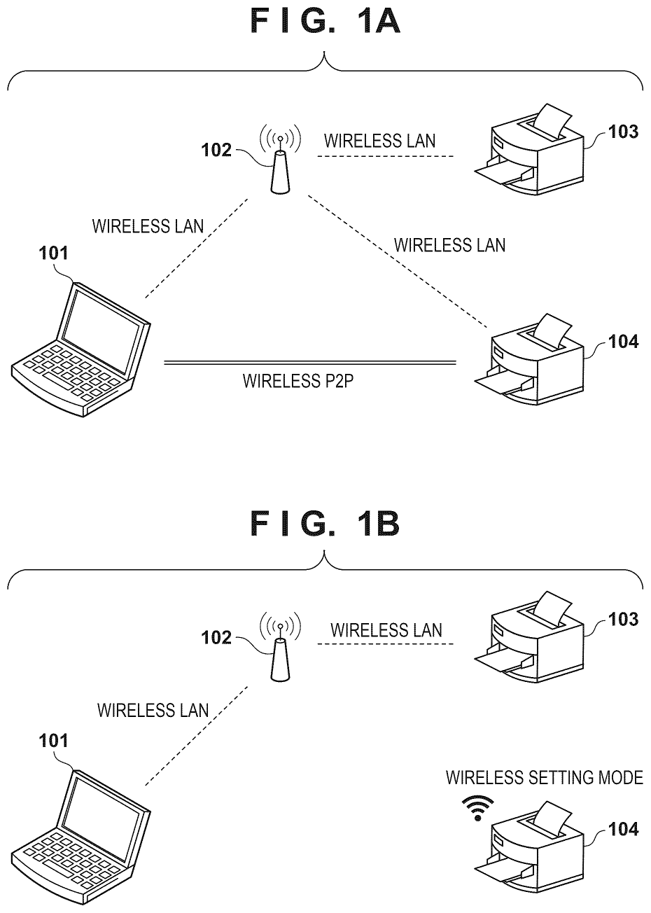

FIGS. 1A and 1B are diagrams showing a system configuration according to the present embodiment. FIG. 1A shows a state in which a PC 101 and an AP 102 are connected via a wireless LAN. In addition, a printer 103 and a printer 104 are also connected to a wireless access point (AP) 102 via a wireless LAN. That is, the PC 101 is in a state in which it can communicate with the printer 103 and the printer 104 via the AP 102, and a wireless infrastructure connection has been established. In this manner, a wireless infrastructure connection can construct a network environment in which a PC can communicate with two or more devices. Note that, for example, if the printer 103 and the AP 102 are connected via a wireless LAN and the PC 101 and the printer 103 are capable of communicating with each other via the AP 102, it can be said that the printer 103 has established a wireless infrastructure connection. That is, the connection between the PC 101 and the AP 102 does not need to be a wireless LAN, and for example, in FIG. 1A, the PC 101 may be connected to the AP 102 via a wired LAN.

On the other hand, there is also a connection method called wireless direct connection, which allows communication only between two devices. FIG. 1A shows a state in which the PC 101 and the printer 104 have established a peer-to-peer connection (hereinafter referred to as a wireless P2P connection) through a wireless direct connection. In the environment shown in FIG. 1A, the PC 101 can detect the printer 103 and the printer 104 as network-connected printers.

FIG. 1B shows a case where the printer 104 operates in the wireless setting mode. The printer 104 operating in the wireless setting mode operates as an AP, and transmits beacon information including SSID information and the like corresponding to the AP. In the environment shown in FIG. 1B, the PC 101 detects the printer 103 as a network-connected printer, and detects the printer 104 as a printer in the wireless setting mode by receiving the beacon information transmitted by the printer 104. That is, the PC 101 can discover the printer 103 as a connected printer, and can discover the printer 104 as a printer in the wireless setting mode.

### Configuration of Each Device

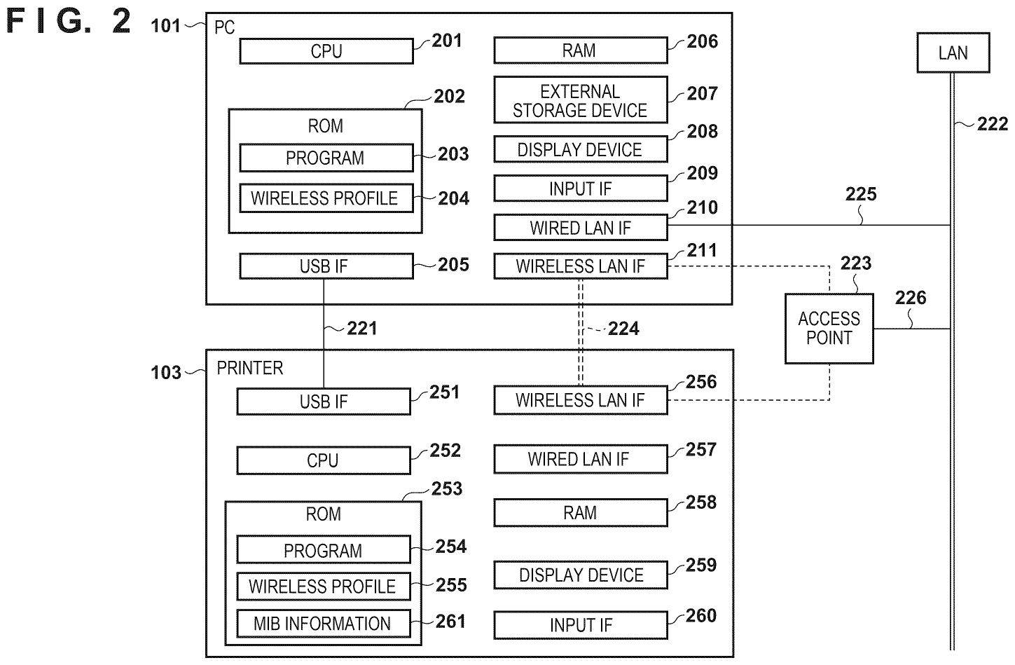

FIG. 2 is a diagram showing a configuration of a communication system including a hardware configuration of the PC 101 (i.e., an electronic device) and the printer 103 (i.e., an external device) in the present embodiment. The PC 101 includes a CPU 201, a ROM 202, a RAM 206, an external storage device 207, a display device 208, and an input IF 209. The PC 101 also includes a USB IF 205, a wired LAN IF 210, and a wireless LAN IF 211. However, the present embodiment is valid even if the PC 101 does not have the USB IF 205 and the wired LAN IF 210.

The ROM 202 stores programs 203 corresponding to various processes including processing for searching for a printer to be set up (hereinafter referred to as setup target printer search processing) and a program for automatic wireless setting processing, a later-described wireless profile 204, and the like. In addition, the external storage device 207 stores an operating system (OS), a printer driver, and various other data. The CPU 201 reads out the program 203 stored in the ROM 202, loads it into the RAM 206, and executes it to execute various types of processing including automatic wireless setting processing. In addition, the display device 208 displays the screens of the OS and the program 203, and the input IF 209 accepts input from the user, enabling input of various types of data and operation instructions.

The PC 101 is capable of P2P connection to the printer 103 via a USB cable 221 or wirelessly via a wireless direct connection 224. In addition, the PC 101 can also be connected to a LAN 222 via an Ethernet cable 225, and if the printer 103 can also be connected to the LAN 222, the PC 101 and the printer 103 can communicate with each other in the same LAN 222 environment. Furthermore, the PC 101 is connected to an AP 223 via the wireless LAN IF 211, and the AP 223 is connected to the LAN 222 via an Ethernet cable 226, thereby enabling the PC 101 to connect to the LAN 222. In addition, if the printer 103 can also be connected to the AP 223, the PC 101 and the printer 103 can communicate with each other via the AP 223.

Here, the wireless profile 204 is information including specific information (SSID, etc.) of the AP 223 connected via the wireless LAN IF 211, authentication information (password, etc.) used in authentication processing, and the like. The wireless profile 204 is stored and managed by the CPU 201 executing the OS included in the external storage device 207.

The printer 103 includes a CPU 252, a ROM 253, a RAM 258, a display device 259, an input IF 260, a USB IF 251, a wireless LAN IF 256, and a wired LAN IF 257. The ROM 253 stores a program 254, a wireless profile 255, MIB information 261, and the like. The CPU 252 reads out a program 254 from the ROM 253 to the RAM 258 and executes the program 254 to perform various controls on the printer 103. In addition, the display device 259 displays the screen of the program 254, and presents the user with information indicating the processing status and the data input acceptance state. In addition, the input IF 260 accepts input from the user, enabling the user to input data and give operation instructions to the program 254. Note that the printer 103 does not need to include the USB IF 251 and the wired LAN IF 257.

The printer 103 is capable of P2P connection to the PC 101 via the USB cable 221 or wirelessly via the wireless direct connection 224. In addition, the printer 103 is connected to the AP 223 via the wireless LAN IF 256, and the AP 223 is connected to the LAN 222 via the Ethernet cable 226, thereby enabling the printer 103 to be connected to the LAN 222. Here, the wireless profile 255 is information including settings such as specific information (SSID, etc.) and authentication information (password, etc.) of the AP 223 connected via the wireless LAN IF 256. The wireless profile 255 is stored and managed by the CPU 252 executing the program 254 included in the ROM 253. For example, when the printer 103 is powered on, the printer 103 can reconnect to the previous network using the wireless profile 255. Furthermore, for example, the printer 103 may be configured to manage a plurality of wireless profiles, like the OS of the PC 101. As described above, the MIB information 261 is a standard for managing network devices, and holds information that can be used by the network management protocol SNMP.

The ROM 253 also stores a unique SSID that is set uniquely for the printer 103. The wireless LAN IF 256 of the printer 103 can operate as an AP corresponding to this unique SSID. For this reason, the PC 101 can connect to the printer 103 operating as an AP via the wireless direct connection 224 in the same manner as when connecting to the AP 223.

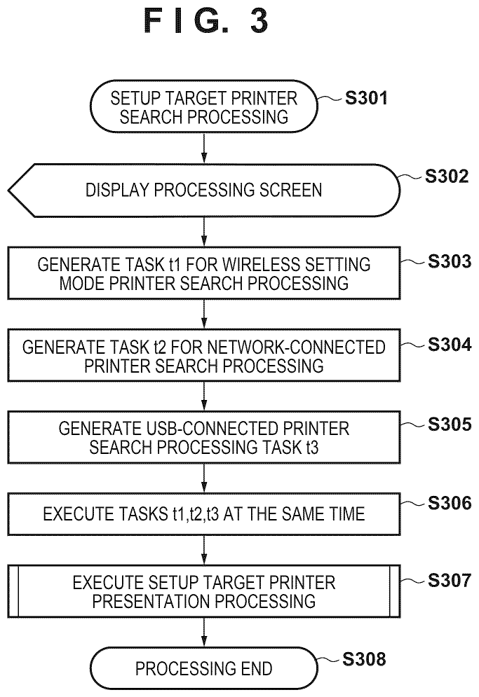

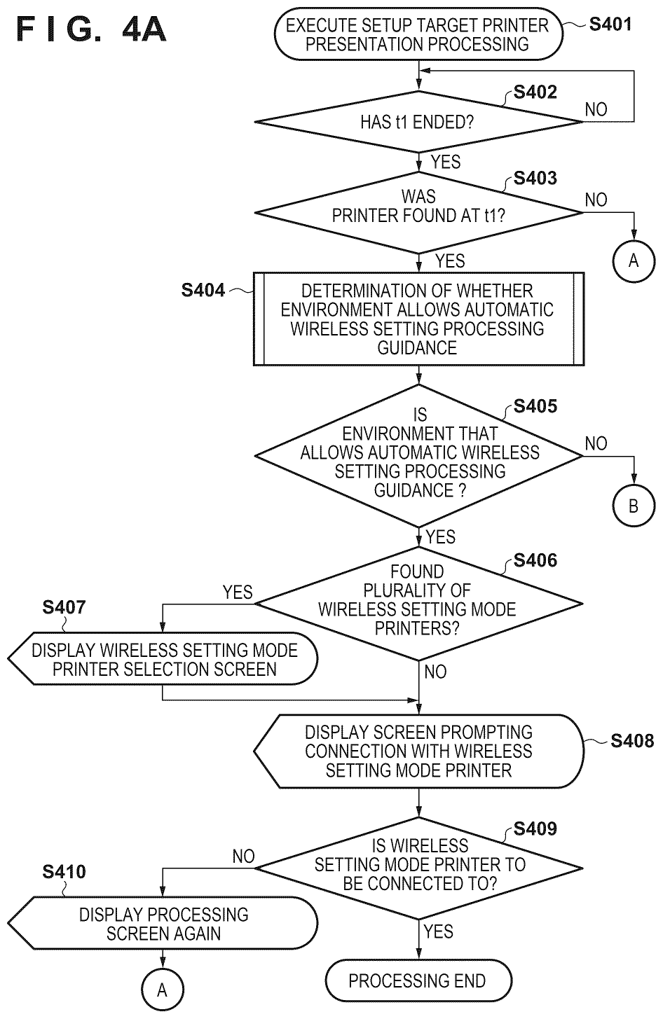

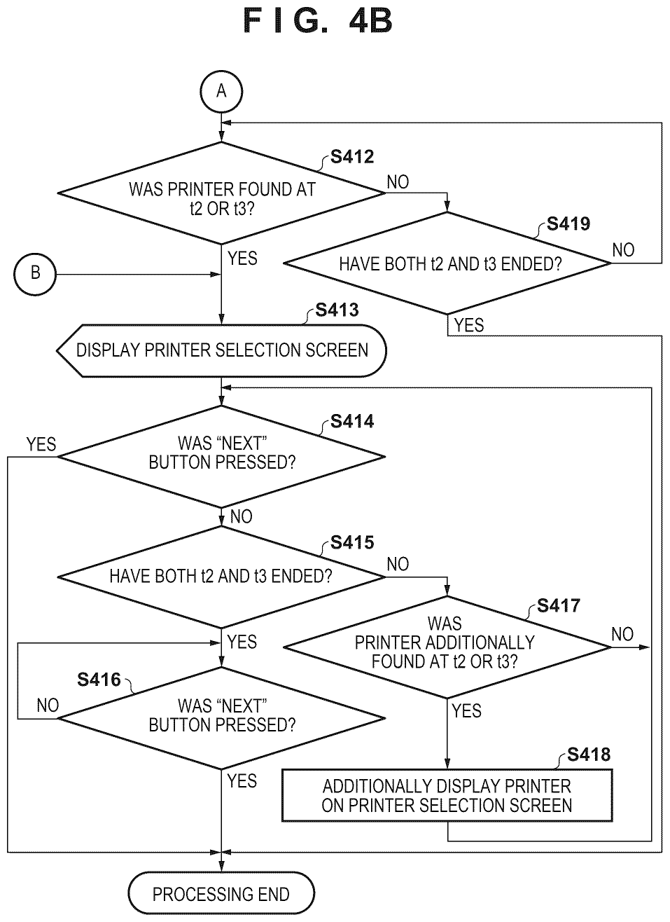

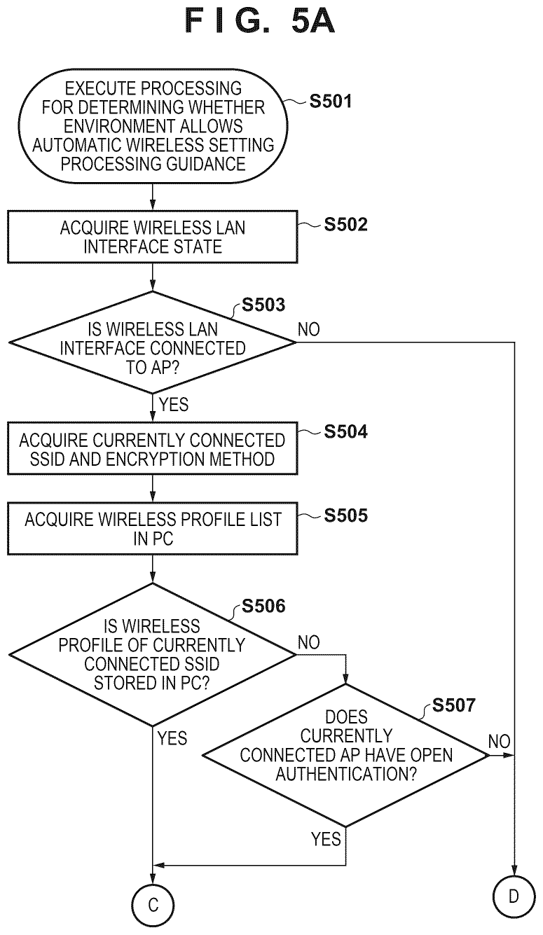

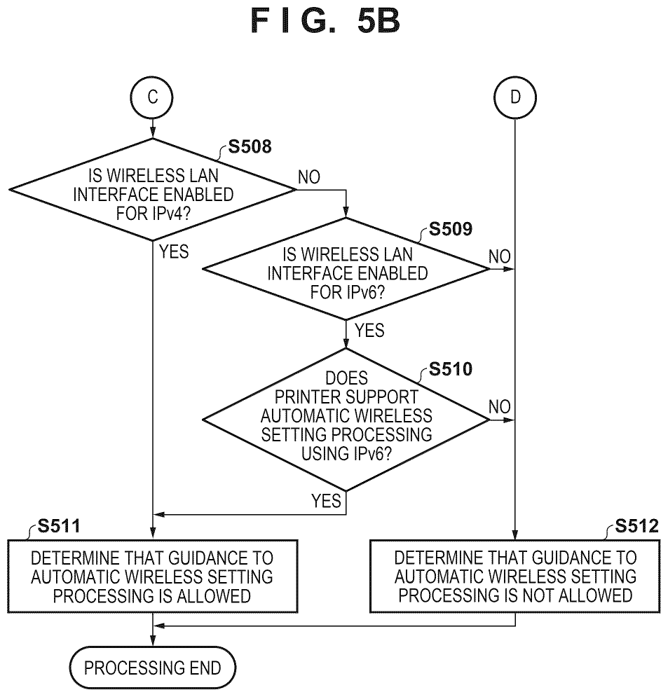

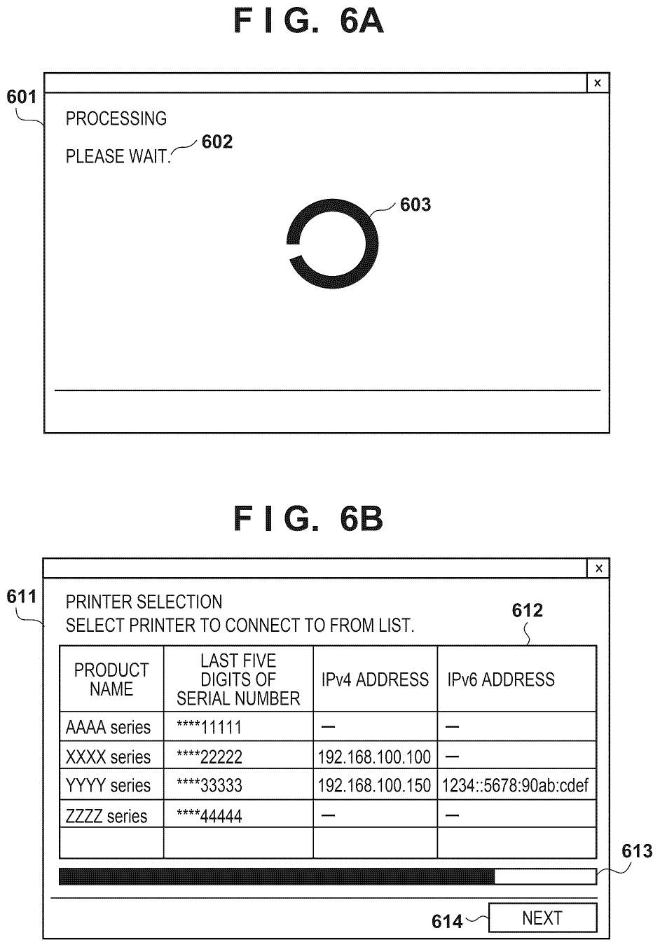

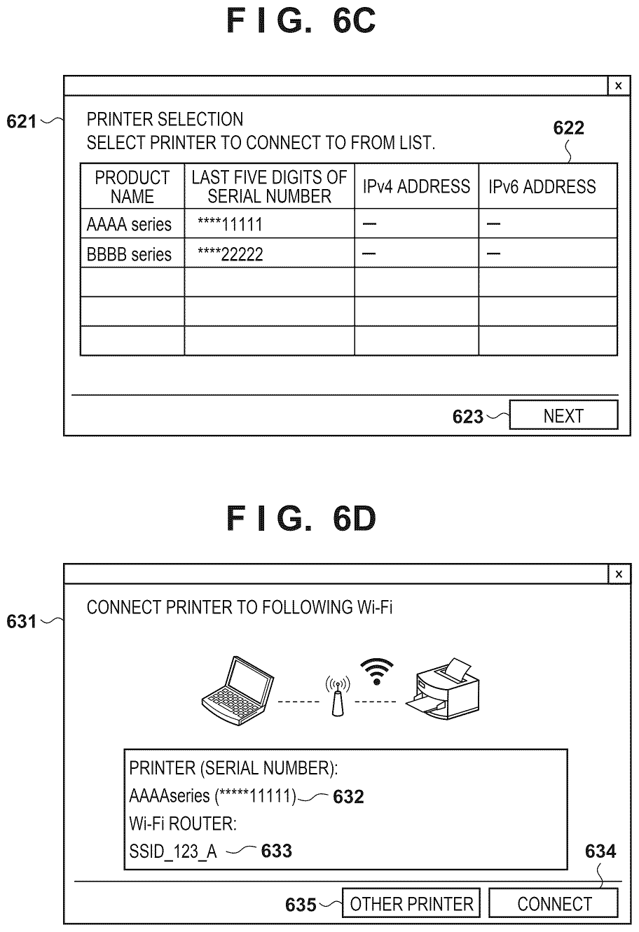

The present embodiment will be described in detail below with reference to FIG. 3 to FIG. 6D. FIG. 3 is a flowchart showing processing for setup target printer search processing executed by the PC 101 in the present embodiment. FIGS. 4A and 4B are flowcharts showing the flow of printer detection processing executed by the PC 101 in step S307 of FIG. 3 in the present embodiment. FIGS. 5A and 5B are flowcharts showing the flow of processing for “automatic wireless setting processing guidability determination” carried out by the PC 101 in step S405 of FIG. 4A in the present embodiment. FIGS. 6A to 6D are diagrams showing examples of screens displayed on the display device 208 of the PC 101 in the processing of the flowcharts shown in FIGS. 3, 4A, and 4B.

### Setup Target Printer Search Processing

The setup target printer search processing in the present embodiment will be described with reference to FIG. 3. FIG. 3 shows the processing for searching for a printer to be set up, and since the user interface screens shown in FIGS. 6A to 6D are displayed during this processing, it can also be said to be a display control processing procedure.

In step S301, the CPU 201 of the PC 101 executes a program (an application, etc.) including setup target printer search processing included in the program 203, thereby starting the setup target printer search processing.

Upon starting the setup target printer search processing in step S301, the CPU 201 displays a processing screen 601 as shown in FIG. 6A in step S302. The processing screen 601 is a search-in-progress screen that includes, for example, a character string 602 indicating that printer search is in progress and an image 603 indicating that printer search is in progress, and indicates to the user that printer search is in progress. The processing screen 601 does not accept a user operation, and the screen display is automatically switched after the CPU 201 executes the processing of step S303 and onward.

Next, in step S303, the CPU 201 generates a task t1 for executing processing for searching for a printer in the wireless setting mode. Here, a task is a mechanism for executing asynchronous processing, and for example, processing to be executed asynchronously can be defined in advance as a task, and thereafter a plurality of tasks can be executed at the same time, thereby achieving parallel processing.

Next, in step S304, the CPU 201 generates a task t2 for network-connected printer search processing. Next, in step S305, the CPU 201 generates a task t3 for USB-connected printer search processing. Then, in step S306, the CPU 201 executes the generated tasks t1, t2, and t3 at the same time, that is, in parallel, to search for each printer by parallel processing. Note that in the present embodiment, the tasks t1, t2, and t3 are generated and search processing for each printer is executed, but search processing for a USB printer does not need to be executed. That is, the CPU 201 does not need to execute the processing of step S305. In addition, in this embodiment, the processing screen 601 is displayed in step S302, and the tasks t1, t2, and t3 are generated in that order, but the order is not particularly limited. For example, it is also possible to employ a mode in which the tasks are generated in the order of t2, t3, and t1, and thereafter the processing screen 601 is displayed. Also, each time a task is generated, its execution may be started.

Next, in step S307, the CPU 201 executes “setup target printer presentation” for presenting the printer to be set up to the user according to the results of the tasks. Step S307 will be described later with reference to FIGS. 4A and 4B. Then, in step S308, the CPU 201 ends the setup target printer search processing.

### Setup Target Printer Presentation Processing

The setup target printer presentation processing (step S307 in FIG. 3) executed by the PC 101 in this embodiment will be described with reference to FIGS. 4A and 4B.

In step S401, the CPU 201 starts setup target presentation processing, and in step S402, the CPU 201 checks the state of the processing of the task t1 to determine whether or not the processing of the task t1 has ended. If it is determined in S402 that the processing of the task t1 has not ended, the processing returns to step S402. On the other hand, if it is determined in step S402 that the processing of the task t1 has ended, the processing proceeds to step S403. In step S403, the CPU 201 determines whether or not a printer in the wireless setting mode has been found in the processing of the task t1. If it is determined that a printer has been found, the processing branches to step S404, and if it is determined that a printer has not been found, the processing branches to step S412. If it is determined in step S403 that a printer in the wireless setting mode has been found, in step S404, the CPU 201 performs processing for determining whether or not the environment allows guidance to automatic wireless setting processing. The processing for determining whether or not the environment allows guidance to the automatic wireless setting processing will be described later with reference to FIGS. 5A and 5B. In step S405, the CPU 201 determines whether or not it has been determined that the environment allows guidance to automatic wireless setting processing, as a result of the processing in step S404. If it has been determined that the environment allows guidance to automatic wireless setting processing, the processing proceeds to step S406. If it has been determined that the environment does not allow guidance to the automatic wireless setting processing, the processing branches to step S413. The processing of step S413 and onward will be described later.

In step S406, the CPU 201 determines whether or not a plurality of printers in the wireless setting mode have been found in the processing of the task t1. If it is determined in step S406 that a plurality of printers in the wireless setting mode have not been found in the processing of the task t1, the processing proceeds to step S408. The processing of step S408 and onward will be described later. On the other hand, if it is determined in step S406 that a plurality of printers in the wireless setting mode have been found in the processing of the task t1, the processing proceeds to step S407.

In step S407, the CPU 201 displays a printer selection screen 621 (also called a first printer selection screen) for the user to select a printer in the wireless setting mode, as shown in FIG. 6C. The first printer selection screen 621 has a list user interface (UI) 622 that displays information on the plurality of printers in the wireless setting mode found in the processing of the task t1, and a “next” button 623. The list UI 622 has items that display the product name, the last five digits of the serial number, the IPV4 address, and the IPV6 address of the printer, which are information that the PC 101 obtains from the printer when the printer is detected. Here, IPv4 is Internet Protocol (IP) version 4 and IPv6 is IP version 6. Note that, regarding information that cannot be obtained when the printer is detected, the CPU 201 of the PC 101 may communicate with the detected printer after the printer is detected and acquire the necessary information from the printer. In the example of the screen shown in FIG. 6C, two printers have been discovered as printers in the wireless setting mode, namely one with the product name “AAAA series” and with a serial number whose last five digits are “****11111”, and one with the product name “BBBB series” and with a serial number whose last five digits are “****66666”. The first printer selection screen 621 shown in FIG. 6C shows how each of the discovered printers is displayed as an option.

Note that a printer in the wireless setting mode is, for example, the printer 103 operating as an AP corresponding to a unique SSID stored in the ROM 253. For this reason, there are no IPv4 or IPv6 addresses that correspond to the printer in the wireless setting mode. That is, the list UI 622 does not need to have items for an IPV4 address and an IPV6 address. Also, the first printer selection screen 621 for selecting the printer in the wireless setting mode waits for acceptance of user input via the input IF 209 of the PC 101. Then, the user selects the printer that the user wishes to set up and presses the “next” button 623 to proceed to the next processing, that is, step S408. By displaying a first printer selection screen 621 for selecting a printer in the wireless setting mode, the PC 101 can narrow down the printers in the wireless setting mode and present them to the user even if a plurality of high-priority printers in the wireless setting mode are found.

When the CPU 201 detects that the user has pressed the “next” button 623 on the first printer selection screen 621 displayed in step S407, the processing proceeds to step S408.

In step S408, the CPU 201 displays a connection guidance screen 631, as shown in FIG. 6D, which prompts connection to the printer in the wireless setting mode. The connection guidance screen 631 has a region 632 that displays the product name and the last five digits of the serial number of the printer in the wireless setting mode that is a candidate to be set up. That is, the guidance screen 631 is also a confirmation screen for confirming the printer to be set up and the AP that is the connection destination. The printer in the wireless setting mode that is a candidate to be set up is the printer selected on the printer selection screen 621 if the processing proceeds from step S407 to step S408, and is the discovered printer in the wireless setting mode if the processing proceeds from step S406 to step S408. The connection guidance screen 631 also has a region 633 that displays the SSID of the AP to which the printer is to be connected in the automatic wireless setting processing. The connection guidance screen 631 also has a “connect” button 634 and an “other printer” button 635.

In step S409, the CPU 201 determines whether or not the printer in the wireless setting mode that is a candidate to be set up is to be connected to. When the user presses the “connect” button 634 according to the guidance on the connection guidance screen 631, the CPU 201 determines in step S409 that the printer in the wireless setting mode displayed on the connection guidance screen 631 is to be connected to, and the processing proceeds to step S411. On the other hand, if the user does not follow the guidance on the connection guidance screen 631 and presses the “other printer” button 635, the CPU 201 determines in step S409 that the printer in the wireless setting mode displayed on the connection guidance screen 631 is not to be connected to, and proceeds to step S410. In step S411, the CPU 201 ends the setup target printer presentation processing. In step S410, the CPU 201 displays the processing screen 601 again, as shown in FIG. 6A. Then, the processing proceeds to step S412, which will be described later, and the processing of step S412 and onward is executed.

If it is determined in step S403 that no printer in the wireless setting mode has been found, or if the processing screen 601 is redisplayed in step S410, step S412 is executed. In step S412, the CPU 201 determines whether or not at least one of a network-connected printer and a USB-connected printer has been found. The network-connected printer is the printer searched for in the processing of the task t2, and the USB-connected printer is the printer searched for in the processing of the task t3. If it is determined in step S412 that neither a network-connected printer nor a USB-connected printer has been found, the processing proceeds to step S420. On the other hand, if it is determined in step S412 that at least one of a network-connected printer and a USB-connected printer has been found, the processing proceeds to step S413.

In step S419, the CPU 201 determines whether or not the processing of both the task t2 and the task t3 has ended. In the present embodiment, the tasks t2 and t3 end in a longer predetermined amount of time than the task t1. If it is determined in step S419 that the processing of both the tasks t2 and t3 has ended, it is determined that no setup target printer has been found, and in step S411, the CPU 201 ends the setup target printer presentation processing.

On the other hand, if it is determined in step S419 that the processing of either the task t2 or the task t3 has not ended, the CPU 201 returns to the processing of step S412.

In step S413, the CPU 201 displays a second printer selection screen 611 as shown in FIG. 6B. The second printer selection screen 611 has a list UI 612, a progress bar 613, and a “next” button 614. The list UI 612 is a UI that displays information on network-connected printers found in the processing of the task t2, or USB-connected printers found in the processing of the task t3, or both. In addition, if a printer in the wireless setting mode is found during the processing of the task t1 but it is determined in step S405 that guidance to automatic wireless setting processing is not possible, the list UI 612 may also display the printer in the wireless setting mode found in the task t1. The list UI 612 has items that display the product name, the last five digits of the serial number, the IPV4 address, and the IPV6 address of the printer.

In the example of the screen shown in FIG. 6B, a printer with the product name “AAAA series” and with a serial number whose last five digits are “****11111” is displayed as an option for a printer in the wireless setting mode. In addition, a printer with the product name “XXXX series” and a printer with the product name “YYYY series” are displayed as options for network-connected printers. Regarding the printer with the product name “XXXX series”, the last five digits of the serial number are displayed as “****22222” and the IPV4 address is displayed as “192.168.100.100”. Regarding the printer with the product name “YYYY series”, the last five digits of the serial number “****33333”, the IPV4 address “192.168.100.150”, and the IPV6 address “1234::5678:90ab:cdef” are also displayed. Furthermore, a printer with the product name “ZZZZ series” and with a serial number whose last five digits are “****44444” is displayed as an option for a USB-connected printer. As mentioned above, the IPV4 and IPv6 addresses of printers in the wireless setting mode are not displayed, and similarly, the IPV4 and IPV6 addresses of printers connected via USB are not displayed. The progress bar 613 indicates that the processing of the task t2 or the task t3 is in progress. Note that in the present embodiment, a progress bar is displayed as a UI indicating that the processing of the task t2 or the task t3 is in progress, but the present invention is not limited to this, and may be configured to display a UI such as an image 603 in FIG. 6A. The “next” button 614 is a button that, when pressed after the user selects a printer to be set up from the list UI 612, confirms the printer to be set up and ends the setup target printer presentation processing. The “next” button 614 can be pressed even when the progress bar 613 is in an active state indicating that a search is in progress, that is, even when the task t2 or the task t3 is being executed.

In step S414, the CPU 201 determines whether or not the “next” button 614 on the second printer selection screen 611 has been pressed by the user. If it is determined in step S414 that the “next” button 614 has been pressed, the processing proceeds to step S411. On the other hand, if the “next” button 614 is not pressed in step S414, the processing proceeds to step S415. In step S411, the CPU 201 determines the printer to be set up, and ends the processing for presenting the printer to be set up. On the other hand, in step S415, the CPU 201 subsequently determines whether the processing of both the tasks t2 and t3 has ended. If it is determined in step S415 that the processing of both the tasks t2 and t3 has ended, the processing proceeds to step S416, and if it is determined that the processing of either the task t2 or the task t3 has not ended, the processing proceeds to step S417. Note that when branching to step S416, the tasks t2 and t3 are complete after the elapse of a predetermined amount of time since the start of execution, and therefore the progress bar 613 that indicates the progress of the search and is included in the printer selection screen 611 in FIG. 6B being displayed indicates that the search is complete. That is, after the tasks t2 and t3 are complete, the progress bar 613 does not indicate that a search is in progress.

In step S416, the CPU 201 determines whether the “next” button 614 has been pressed again. Then, in step S416, if it is determined that the “next” button 614 has been pressed by the user, the processing proceeds to step S411, and if not, the determination in step S416 is repeated. In step S411, the CPU 201 determines the printer to be set up, and ends the setup target printer presentation processing.

On the other hand, in step S417, the CPU 201 determines whether at least one of an additional network-connected printer and an additional USB-connected printer was found. The additional network-connected printer is a printer that can be discovered through the processing of the task t2, and the additional USB-connected printer is a printer that can be discovered through the processing of the task t3. If it is determined in step S417 that at least one additional network-connected printer or USB-connected printer was found, the processing proceeds to step S418. If it is determined in step S417 that neither an additional network-connected printer nor an additional USB-connected printer was found, the processing returns to the determination in step S414.

In step S418, the CPU 201 adds information on the found printer to the list UI 612 of the printer selection screen 611 being displayed, and displays the information.

Note that in the present embodiment, even if one printer in the wireless setting mode is determined as a candidate for a printer to be set up in step S406 or S407, the connection guidance screen 631 prompting connection to the printer in the wireless setting mode is displayed in step S408. This allows the user to select a connected printer in a case where the user wishes to execute setup processing (such as driver installation) other than connection processing for the connected printer. However, the connection guidance screen 631 does not need to be displayed. That is, at a timing when there is only one printer in the wireless setting mode that is a candidate to be set up in step S406 or S407, the CPU 201 may determine that printer as the printer to be set up, and end the setup target printer presentation processing. In this case, steps S408 and S409 are skipped and the processing ends at step S411, and therefore the user cannot select a printer to be set up from among the connected printers found in the processing of task t2 or task t3. However, this reduces the number of user steps on the screen 631 displayed in step S408 and allows a high-priority printer in the wireless setting mode to be determined as the printer to be set up, thereby improving user convenience. In addition, in a mode in which the screen 631 in step S408 is not displayed, the CPU 201 may end the processing of the tasks t2 and t3 at the timing when it is determined in step S405 that the environment allows guidance to the automatic wireless setting processing.

After the processing in FIGS. 4A and 4B ends, the screen displayed on the PC 101 may be, for example, a screen using the selected connected printer if the processing ends by pressing the “next” button in step S414 or S416. Also, when connecting to a printer in the wireless setting mode in step S409 as well, a screen using the selected connected printer may be displayed after the connection processing, or the like. In addition, if it is determined in step S419 that the tasks t2 and t3 have ended and the processing of FIG. 4B is to be ended, a message indicating that no candidate printers were found may be displayed, or the like. In either case, the screens of FIGS. 6A to 6D displayed during the processing of FIGS. 4A and 4B may be replaced with other screens when the processing of FIGS. 4A and 4B ends.

In this way, according to the processing of FIGS. 4A and 4B, the application can search for printers in the wireless setting mode, printers connected to an AP, or printers connected via USB, and display them as a list of candidate printers to be connected. The user can select a printer from the list. If the selected printer is a printer in the wireless setting mode, the application can connect to the printer through a predetermined procedure. The connection processing involves, for example, directly connecting to a printer in the wireless setting mode, and transmitting connection information for connecting to the AP via the direct connection, such as an SSID and a password (or a passkey), to the printer in the wireless setting mode. The printer in the wireless setting mode uses the received information to connect to the AP. This allows the printer in the wireless setting mode to be connected to the communication network, enabling communication with other devices connected to the network. Furthermore, the connected device can set up and use the printer via communication.

Furthermore, in the processing of FIGS. 4A and 4B, if a printer in the wireless setting mode is found, regardless of whether or not other candidate printers have been found, a screen for connecting to the printer in the wireless setting mode is displayed, and the user can be guided to the processing for connecting to the printer in the wireless setting mode. The search for printers connected via wireless LAN or USB performed using the second method takes longer than the search for printers in the wireless setting mode performed using the first method. For this reason, if a printer in the wireless setting mode is within the search range, it can be discovered before the search for connected printers ends. In view of this, if a printer in the wireless setting mode is found and a predetermined condition regarding an access point to which the printer can connect is satisfied, a screen for connecting to the printer can be displayed after the elapse of a certain amount of time since the start of the search and before the search for connected printers ends. The predetermined condition here is the condition determined in the procedure of FIGS. 5A and 5B. In other words, in a situation where a printer in the wireless setting mode is discovered, a screen for connecting to the printer in the wireless setting mode is displayed regardless of whether or not a connected printer has been discovered, and regardless of the time that has elapsed since the start of the search.

On the other hand, in a situation where a printer in the wireless setting mode cannot be found, regardless of whether or not a connected printer is found, a screen indicating that a search is in progress is displayed until the elapse of the predetermined time at the earliest, unless a user operation is performed. At this time, if any new printers are discovered, the discovered printers are additionally displayed on the displayed screen.

Next, the determination processing (step S404 in FIG. 4A) in the present embodiment for determining whether the environment allows guidance to the automatic wireless setting processing executed by the PC 101 will be described with reference to FIGS. 5A and 5B.

In step S501, the CPU 201 starts determination processing for determining whether the environment allows guidance to the automatic wireless setting processing. In step S502, the CPU 201 acquires the state of the wireless LAN interface 211. Specifically, the CPU 201 executes a predetermined application programming interface (API) of the OS to acquire information indicating whether or not the wireless LAN IF 211 is connected to an AP. In step S503, the CPU 201 determines whether or not the state of the wireless LAN IF 211 is a value indicating being currently connected to an AP. If it is determined that the state of the wireless LAN IF 211 is a value indicating being currently connected to an AP, the processing proceeds to step S504, and if not, that is, if it is determined that the wireless LAN IF 211 is not connected to the AP, the processing proceeds to step S512.

In step S512, the CPU 201 determines that the current environment is an environment that does not allow guidance to the automatic wireless setting processing. The result of the determination is stored in, for example, the RAM 206, and is referred to when making the determination in step S405. Then, in step S519, the CPU 201 ends the determination processing for determining whether or not the environment allows guidance to the automatic wireless setting processing.

On the other hand, in step S504, the CPU 201 acquires information on the AP to which the wireless LAN IF 211 is currently connected (hereinafter, referred to as connected AP information). At this time, the CPU 201 executes a predetermined API of the OS to obtain specific information (SSID, etc.) and authentication information (encryption method, etc.) of the AP 102 as the connected AP information.

Next, in step S505, the CPU 201 acquires all of the wireless profiles 204 stored in the ROM 202. Specifically, the CPU 201 acquires a list of the wireless profiles 204 stored in the ROM 202 by executing a predetermined API of the OS. Alternatively, the CPU 201 acquires the list of the wireless profiles 204 from a folder or registry in which the OS stores the wireless profiles 204, without executing the API.

The CPU 201 determines in steps S506 and S507 whether it is possible to acquire setting information (including SSID and password) of the AP 102 to be transmitted to the printer 103 in the automatic wireless setting processing from the information acquired in steps S504 and S505. The connected AP information acquired by the CPU 201 in step S504 does not include a password required for connecting to the AP 102. For this reason, the CPU 201 obtains a password from the wireless profile acquired in step S505. In addition, if the CPU 201 cannot acquire the setting information of the AP 102, the CPU 201 does not guide the user to the automatic wireless setting processing because it is necessary for the user to designate the setting information of the AP 102.

First, in step S506, the CPU 201 determines whether or not the SSID of the AP 102 acquired in step S504 is included in the list of the wireless profiles 204 acquired in step S505. If it is determined that it is not included, the processing proceeds to step S507. If it is determined that it is included, it is determined that the setting information (including the SSID and password) of the AP 102 can be acquired from the wireless profile, and the processing of step S508 and onward are executed. The processing of S508 and onward will be described later.

In step S507, the CPU 201 determines whether or not the encryption method is set in the AP 102, that is, whether or not the AP 102 has open authentication, that is, whether or not encryption is set for the AP 102. If it is determined in step S507 that the AP 102 has open authentication, that is, that encryption is not set, there is no need to set a password when connecting to the AP 102. That is, the CPU 201 does not need to obtain the setting information of the AP 102 from the wireless profile 204. For this reason, in this case, it is determined that the setting information for the AP 102 can be acquired from the connected AP information acquired in step S504, and the processing proceeds to step S508. On the other hand, if it is determined in step S507 that the AP 102 does not have open authentication, password information for the AP 102 cannot be obtained, and therefore the processing proceeds to step S512, where information indicating that the current environment does not allow guidance to the automatic wireless setting processing is stored, and the processing ends. Note that it may be determined whether or not the AP 102 has open authentication based on the connected AP information acquired in step S504.

If it is determined in steps S506 and S507 that the setting information of the AP 102 can be acquired, it is then determined whether the wireless LAN IF 211 of the PC 101 is in a state in which the automatic wireless setting processing can be executed. That is, the PC 101 determines whether a wireless P2P connection with the printer 103 is possible. More specifically, the PC 101 determines whether or not the wireless LAN IF 211 supports a communication protocol supported by the printer 103. Generally, the printer 103 has IPv4 as a communication protocol in the network. In view of this, in step S508, the CPU 201 determines whether or not the wireless LAN IF 211 is enabled for communication using IPv4, based on the state of the wireless LAN IF 211 acquired in step S502. If it is determined in step S508 that communication by IPv4 of the wireless LAN IF 211 is enabled, it is determined that the current environment is an environment that allows guidance to the automatic wireless setting processing. In this case, the CPU 201 in step S511 stores, in the RAM 206 or the like, information indicating that the environment allows guidance to the automatic wireless setting processing. The information stored in step S511 is referenced in step S405 of FIG. 4A. Then, in step S513, the CPU 201 ends the determination processing for determining whether or not the environment allows guidance to the automatic wireless setting processing.

On the other hand, if it is determined in step S508 that the IPV4 of the wireless LAN IF 211 is not enabled (or is disabled), the processing proceeds to step S509. In step S509, the CPU 201 determines whether or not IPv6 of the wireless LAN interface 211 is enabled. If it is determined in step S509 that the IPV6 of the wireless LAN IF 211 is not enabled (is disabled), the processing proceeds to step S512. On the other hand, if it is determined in step S509 that IPv6 of the wireless LAN IF 211 is enabled, the processing proceeds to step S510.

In step S512, the CPU 201 stores, in the RAM 206 or the like, information indicating that the environment does not allow guidance to the automatic wireless setting processing. Then, in step S513, the CPU 201 ends the determination processing for determining whether the environment allows guidance to the automatic wireless setting processing.

On the other hand, in step S510, the CPU 201 determines whether or not the printer 103 supports wireless P2P connection using IPV6. Specifically, the CPU 201 determines whether or not the printer 103 supports wireless P2P connection using IPv6, based on the unique SSID for the wireless setting mode of the printer 103 found in the processing of task t1. More specifically, if the unique SSID for the wireless setting mode of the printer 103 includes a specific character string indicating support for IPV6, the CPU 201 determines that the printer 103 supports wireless P2P connection using IPV6. Note that in the present embodiment, a configuration in which a specific character string indicating IPv6 support is included in the unique SSID for the wireless setting mode of the printer 103 has been described as an example, but the present invention is not limited to this. For example, a method may be used in which it is determined whether the PC 101 is a model that supports wireless P2P connection using IPv6, based on a model name included in the unique SSID for the wireless setting mode of the printer 103.

If it is determined in step S510 that the printer 103 supports wireless P2P connection using IPv6, that is, that the printer 103 supports automatic wireless setting processing using IPv6, the processing proceeds to step S511. Then, in step S511, the CPU 201 stores, in the RAM 206 or the like, information indicating that the environment allows guidance to the automatic wireless setting processing. Next, in step S513, the CPU 201 ends the determination processing for determining whether or not the environment allows guidance to the automatic wireless setting processing.

On the other hand, if it is determined in step S510 that the printer 103 does not support wireless P2P connection using IPV6, that is, the printer 103 does not support automatic wireless setting processing using IPv6, the processing proceeds to step S512. In step S512, the CPU 201 stores, in the RAM 206 or the like, information indicating that the environment does not allow guidance to the automatic wireless setting processing. Next, in step S513, the CPU 201 ends the determination processing for determining whether or not the environment allows guidance to the automatic wireless setting processing.

Note that if the PC 101 is equipped with a plurality of wireless LAN IFs 211, the PC 101 executes the processing of this flowchart for all the wireless LAN IFs. In this case, it is not necessary for the guidability condition to be met in one wireless LAN IF. That is, it is assumed that the PC 101 determines that the first wireless LAN IF having a communication protocol capable of wireless P2P connection with the printer 103 is not in a connected state with the AP 102 (No in step S503). Even in this case, if there is at least one second wireless LAN IF from which connection information of the AP 102 can be acquired (Yes in steps S503 and S506, or Yes in steps S503 and S507), it is determined that the environment allows guidance to automatic wireless setting processing.

In this way, in the processing of FIGS. 5A and 5B, based on the acquired information, it is possible to determine whether or not the current communication system environment allows the user to be guided to the automatic wireless setting processing for the printer, and it is possible to save the determination result.

According to the above embodiment, in the search processing performed by the PC 101 to determine the printer to be set up during the setup processing, it is possible to present, to the user, a high-priority printer in the wireless setting mode at the timing when the printer is found. If a plurality of printers in the wireless setting mode are found, the printers in the wireless setting mode that are found are narrowed down and presented to the user for selection. This allows the user to proceed with the setup processing without waiting for the search results of the low-priority connected printers.

In addition, if a low-priority connected printer is found before the printer in the wireless setting mode, the low-priority connected printer is not presented to the user until the search processing for the printer in the wireless setting mode ends, that is, until the task t1 ends. This makes it possible to prevent user confusion, such as the user unintentionally selecting a low-priority connected printer. In addition, after the search processing for the printer in the wireless setting mode ends without a printer in the wireless setting mode being found, if a connected printer is found at that point in time, the search processing for the connected printer is continued while presenting the found connected printer to the user. This allows the user to select a printer from among the found connected printers without waiting for the completion of the connected printer search processing. As a result of the above processing, the waiting time of the user during the printer search result processing of the setup processing is reduced, improving user convenience.

Note that the various controls described above as being performed by the CPU 201 may be performed by a single piece of hardware, or the entire device may be controlled by a plurality of pieces of hardware (e.g., a plurality of processors or circuits) sharing the processing.

In addition, although the present invention has been described in detail based on preferred embodiments thereof, the present invention is not limited to these specific embodiments, and various modes that do not deviate from the gist of the present invention are also encompassed in the present invention. Furthermore, each of the above-described embodiments merely shows one embodiment of the present invention, and the embodiments can be combined as appropriate.

In addition, in the above-described embodiments, the present invention has been described as being applied to the setup of a printer using an application program, but this is not limited to this example and can be applied to any setup using an information processing device of a wirelessly connected communication device. That is, the present invention is applicable to the setup of devices with communication functions, such as portable image viewers, printer devices with displays, digital photo frames, music players, game consoles, and e-book readers using personal computers, PDAs, and mobile phone terminals.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-139979, filed on Aug. 21, 2024 which is hereby incorporated by reference herein in its entirety.

What is claimed is:

1. An electronic device capable of communicating with an external device, the electronic device comprising:
at least one memory and at least one processor which function as:
a search unit configured to search for an external device using a plurality of methods including a first method and a second method; and
a display control unit configured to
control the electronic device such that a search-in-progress screen is displayed when search is started by the search unit,
control the electronic device such that, in a situation where a first external device that is discoverable using the first method and a second external device that is discoverable using the second method are present, in a case where the first external device is found by search using the first method and a predetermined condition regarding a first access point to which the electronic device can be connected is satisfied, a first screen for connecting to the first external device is displayed before elapse of a predetermined time since the start of the search by the search unit, without setting the second external device as a candidate for a connection destination, and
control the electronic device such that, in a situation where the external device that is discoverable using the first method is not present but the second external device that is discoverable using the second method is present, even if the second external device is found in the search using the second method, a second screen indicating that search is in progress is displayed at least until the elapse of the predetermined time, unless a user operation is performed.

2. The electronic device according to claim 1, wherein
the predetermined condition is that connection information for connecting to the first access point is stored in a memory readable by the electronic device.

3. The electronic device according to claim 2, wherein
the connection information includes an SSID and a passkey.

4. The electronic device according to claim 1, wherein
the predetermined condition includes that encryption is not set for the first access point.

5. The electronic device according to claim 1, wherein
the predetermined condition includes that a communication protocol for performing communication between the first access point and the external device is enabled.

6. The electronic device according to claim 1, wherein
in a first case where, in a situation where the first external device that is discoverable using the first method and the second external device that is discoverable using the second method are present, the predetermined condition is not satisfied even if the first external device is found, the display control unit performs control such that the second external device is also displayed as a candidate for a connection destination based on a fact that the second external device was found, without displaying the first screen for connecting to the first external device before the elapse of the predetermined time since the start of the search by the search unit.

7. The electronic device according to claim 6, wherein
in the first case, the display control unit performs control such that the second screen indicating that search is in progress is displayed at least until the elapse of the predetermined time, unless a user operation is performed.

8. The electronic device according to claim 1, wherein
the first access point is a wireless access point to which the electronic device is currently connected, and the predetermined condition is not satisfied in a case where the electronic device is not connected to a wireless access point.

9. The electronic device according to claim 1, wherein
in a case where the predetermined condition is satisfied, furthermore the first screen is displayed, and furthermore the first access point and the first external device are to be connected to each other, then control is performed such that a direct connection for connecting the electronic device and the first access point to each other without going through an access point is established, and connection information that is for connecting to the first access point via the direct connection and includes an SSID and a passkey is transmitted from the electronic device to the first external device, thereby enabling the first external device to connect to the first access point.

10. The electronic device according to claim 1, wherein
in a case where a plurality of the first external devices are found, the first screen includes a list of the plurality of first external devices that were found, and
in response to selection of a first external device from the list, control is performed so as to connect the selected first external device to the first access point.

11. The electronic device according to claim 1, wherein
in a case where only one first external device is found, the first screen includes a confirmation screen for connecting the first external device to the first access point.

12. The electronic device according to claim 1, wherein
the predetermined time is a period of time from when the search unit starts the search for the second external device using the second method to when the search unit ends the search.

13. The electronic device according to claim 1, wherein
the first method is a method of searching for a beacon transmitted by an access point included in the first external device, and
the second method is a method of searching for the second external device connected to the electronic device wirelessly or via a wire.

14. The electronic device according to claim 1, wherein
the first external device and the second external device are printers.

15. A non-transitory computer-readable storage medium storing a program that, when loaded to a computer and executed, causes the computer to execute processing, the processing comprising:
searching for an external device using a plurality of methods including a first method and a second method;
controlling the electronic device such that a search-in-progress screen is displayed when the searching is started;
controlling the electronic device such that, in a situation where a first external device that is discoverable using the first method and a second external device that is discoverable using the second method are present, in a case where the first external device is found by search using the first method and a predetermined condition regarding a first access point to which the electronic device can be connected is satisfied, a first screen for connecting to the first external device is displayed before elapse of a predetermined amount of time since the start of the searching, without setting the second external device as a candidate for a connection destination; and
controlling the electronic device such that, in a situation where the external device that is discoverable using the first method is not present but the second external device that is discoverable using the second method is present, even if the second external device is found by search using the second method, a second screen indicating that search is in progress is displayed at least until the elapse of the predetermined time, unless a user operation is performed.

16. A display method for an electronic device capable of communicating with an external device, comprising:
searching for an external device using a plurality of methods including a first method and a second method;
controlling the electronic device such that a search-in-progress screen is displayed when the searching is started;
controlling the electronic device such that, in a situation where a first external device that is discoverable using the first method and a second external device that is discoverable using the second method are present, in a case where the first external device is found by search using the first method and a predetermined condition regarding a first access point to which the electronic device can be connected is satisfied, a first screen for connecting to the first external device is displayed before elapse of a predetermined time since the start of the searching, without setting the second external device as a candidate for a connection destination; and
controlling the electronic device such that, in a situation where the external device that is discoverable using the first method is not present but the second external device discoverable using the second method is present, even if the second external device is found by search using the second method, a second screen indicating that search is in progress is displayed at least until the elapse of the predetermined time, unless a user operation is performed.
